(19) United States
(12) Patent Application Publication
(10) Pub. No.: US 2013/0297532 A1
(43) Pub. Date: Nov. 7, 2013

(54) System And Method For Rating A Financial Portfolio

(71) Applicant: Christopher L. Snyder, New Canaan, CT (US)

(72) Inventor: Christopher L. Snyder, New Canaan, CT (US)

(21) Appl. No.: 13/888,125

(22) Filed: May 6, 2013

Related U.S. Application Data
(60) Provisional application No. 61/642,551, filed on May 4, 2012.

(51) Int. Cl. G06Q 40/06

(52) U.S. Cl. CPC G06Q 40/06
USPC 705/36 R

(57) ABSTRACT

System and method for ranking the performance of a first portfolio relative to the performance of a plurality of portfolios. Software executing on a server determines a ranking for a first portfolio associated with a first client identifier. The ranking is based on a comparison between the performance of the first portfolio and the performance of the plurality of portfolios. Each of the portfolios is associated with a client identifier. Software executing on the server generates a report based on the first portfolio ranking and transmits the report to the client. The performance ranking may be based on a peer group. Financial advisors are rated based on the performance of portfolios they manage relative to other portfolios in the same peer group.

### FIELD OF THE INVENTION

The present invention relates to investment portfolios. In particular, the present invention relates to a system and method for rating performance of investment portfolios and a system and method for rating performance of financial advisors who manage investment portfolios.

### BACKGROUND OF THE INVENTION

There are more than sixty million investors in the United States. One category of investors, for example, is referred to as mass affluent investors. Mass affluent investors typically refers to the high end of the mass market. Mass affluent investors are typically individuals with $100,000 to $1,000,000 of liquid financial assets, and with an annual household income of about $75,000 and up. Mass affluent investors are an important target for sellers of affordable luxuries. In the United States there are approximately 33 million mass affluent households, and they own roughly 37% of the United State's liquid financial assets. Among family households, approximately thirty percent can be described as being mass affluent. The typical mass affluent investor will have between $500,000 and $1.5 million in investable assets upon retirement with a net worth between $500,000 and $2.5 million. The typical mass fluent investor spends between $4,000 and $10,000 per month in retirement.

An investor, for example a person in the mass affluent category, typically has one or more sources of income. The investor may maintain a checking account, and one or more traditional savings account. In addition to the checking and savings accounts, mass affluent investors may have one or more defined contribution accounts. Additionally, such an investor will have a number of other investments through a bank, a broker, or a financial advisor. In addition, the investor may have a number of assets, such as a primary home, a second home, one or more automobiles, and a boat. In addition, the investor typically has a number of debts, such as one or more mortgages, a student loan, a credit card, and a business loan.

A problem for investors is that they cannot at their portfolio from a single place because the investments are managed, as indicated above, by a number of unrelated third parties, such as banks, brokers, and other financial intuitions. Therefore, in order to obtain an accurate picture of a portfolio, an investor must individually collect information from each financial institution maintaining a portion of his portfolio.

Systems and method are well known for providing a comprehensive picture of a portfolio. For example, account aggregators compile information from different accounts, which may include bank accounts, credit card accounts, investment accounts, and other consumer or business accounts, in a single place. Account aggregators provide services that help users manage their money using web-based software applications. Multiple U.S. financial institutions and credit unions are providing such services, however most of the time a vendor, such as Pageonce, Cash Edge or Yodlee, is the technology solutions provider. Financial advisors are another group that can provide account aggregation services, either independently or with support of an underlying aggregator. Financial advisors typically provide clients with financial products and services, depending on the licenses they hold and the training they have.

A disadvantage of known systems and methods is that while they may provide an accurate picture of an investor's portfolio, known systems and methods do not rank the performance of the investor's portfolio relative to the performance of other portfolios held by third parties.

Another disadvantage of known systems and methods is that they do not rank the performance of the investor's portfolio relative to the performance of other portfolios held by third parties in a peer group of the investor.

Another disadvantage of known system and methods is that they do not allow an investor to compare his investment strategy with that of a higher rated portfolio owned by a member of the investor's peer group.

Another disadvantage of known systems and methods is that they do not provide an objective rating of financial advisors.

Another disadvantage of known systems and methods is that they do not provide an objective rating of financial advisors based on the performance of a plurality of the advisor's clients within a specific peer group.

Another disadvantage of known systems and methods is that they do not allow an investor to determine the effectiveness of her financial advisor relative to other financial advisors that serve her peer group.

### SUMMARY OF THE INVENTION

The present invention resides in one aspect in a system for ranking the performance of a first portfolio relative to the performance of a plurality of portfolios. The system includes a server and a database including a plurality of client identifies, each of the client identifiers has a portfolio associated therewith. Software executing on the server determines a ranking for the first portfolio associated with a first client identifier. The ranking is based on a comparison between the performance of the first portfolio and the performance of the plurality of portfolios. Each of the portfolios is associated with a client identifier. Software executing on the server generates a report based on the first portfolio ranking. A communication link is provided between the server and a network. Software executing on the server transmits the report to a client computer associated with the first client identifier via the communication link.

In other embodiments of the present invention, the system includes software for generating an enrollment form and transmitting the enrollment form to the client computer via the communication link. The system further includes software executing on the server for receiving a reply to the enrollment form including first client data indicative of the first client. The server further includes software executing thereon for associating the received data with the first client identifier and storing the received data in the database.

In some embodiments of the present invention, the system includes software executing thereon for generating an aggregation request to retrieve account information regarding one or more of the financial accounts of the client maintained by one or more third parties. Software executing the server transmits the aggregation request and further receives a reply to the aggregation request, the reply including information regarding the one or more financial accounts of the client maintained by the one or more third parties. The system further includes software executing on the server for associating the received information with the first client identifier and storing the received information in the database.

In yet another embodiment of the present invention, the system includes software executing on the server for defining a first peer group, the first peer group including client identifiers associated with clients having one or more similarities based on the data received during enrollment.

In yet other embodiments of the present invention, the first portfolio and the plurality of portfolios to which the performance comparison is made are associated with client identifiers in the same peer group.

In yet another embodiment of the present invention, the system includes software executing thereon for generating a financial advisor identification form. Software executing on the server transmits the financial advisor identification form to the client computer via the communication link. Software executing on the server receives a reply to the financial advisor identification form. The reply includes a financial advisor identifier indicative of a financial advisor associated with the first client. Software executing on the server stores the financial advisor identifier in the database and associates the financial advisor identifier with the performance of the first client's portfolio.

In yet another embodiment of the present invention, software executing on the server determines a first financial advisor performance rating by comparing the performance of a plurality of portfolios associated with a first financial advisor with the performance of a plurality of portfolios, each of the plurality of portfolios being associated with a financial advisor different than the first financial advisor.

In yet further embodiments of the present invention, the financial advisor rating is based on a comparison of the performance of the financial advisor within a peer group.

The present invention resides in other aspects in a method for ranking the performance of a first portfolio relative to the performance of a plurality of portfolios. The method includes the steps of providing a plurality of client identifiers, each of the client identifiers having a portfolio associated therewith. Determining a ranking for a first portfolio associated with a first client identifier based on a comparison between the performance of the first portfolio and the performance of a plurality of portfolios, each of the portfolios being associated with a client identifier. Generating a report based on the first portfolio ranking. Transmitting the report to a client associated with the first client identifier.

The invention and its particular features and advantages will become more apparent from the following detailed description considered with reference to the accompanying drawings.

### BRIEF DESCRIPTION OF THE DRAWINGS

FIG. 1 illustrates a system and method in accordance with one embodiment of the present invention.

FIG. 2A illustrates a portion of system and method in accordance with one embodiment of the present invention in which enrollment information is received from a client.

FIG. 2B illustrates a plurality of reports generated by a system and method in accordance with one embodiment of the present invention.

FIG. 3 illustrates a portion of system and method in accordance with one embodiment of the present invention in which enrollment information is received from a client.

FIG. 4A illustrates a system and method in accordance with one embodiment of the present invention.

FIG. 4B illustrates a report generated by a system and method in accordance with one embodiment of the present invention.

FIG. 5 illustrates a report generated by a system and method in accordance with one embodiment of the present invention.

FIG. 6 illustrates a dashboard generated by a system or a method in accordance with one embodiment of the present invention.

FIG. 7 illustrates a portion of a system and method in accordance with one embodiment of the present invention.

### DETAILED DESCRIPTION OF THE INVENTION

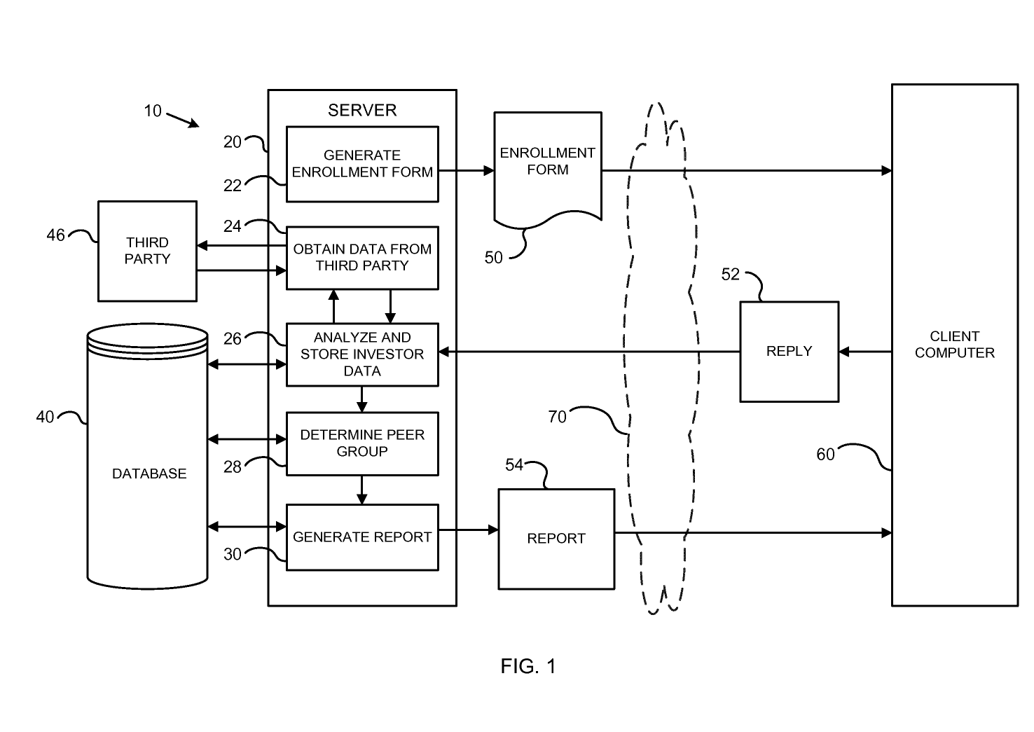

FIG. 1 illustrates a system 10 in accordance with one embodiment of the present invention for assigning a ranking to a first portfolio based on a performance of that portfolio relative to the performance of a plurality of portfolios. The system 10 includes a server 20 having software executing thereon. The server 20 is in communication with a network 70 via a communication link. The network 70 may be, for example, the internet, an intranet, or some other type of network. A client computer 60 is in communication with the network 70 and can communicate with the server 20 via the network 70. Although one client computer 60 is explicitly illustrated in FIG. 1, it should be understood that a plurality of client computers 60 communicate with the server 20 via the network 70. In this way, the server 20 can access and store a plurality of client portfolios and further provide objective comparisons of the performance of each portfolio. It should be understood that the term ranking is used herein to denote that the system performs an objective comparison of the performance of a plurality of portfolios. Based on the results of this comparison, the plurality of portfolios are ranked in order from best to worst performing. In some embodiments, as further described below, the portfolios are rated based on these rankings.

The server 20 may be any type of computer hardware that is configured to execute software and communicate with client computers 60 and other third parties 46 via a network. Although the term server is generally used through out this disclosure, it is not intended to limit the present invention to a specific type of computer. Moreover, it should be understood that the server 20 may comprise a plurality of computers that communicate via a network. In yet other embodiments, the server 20 may comprise one or more cloud computers, including hardware and software, which are maintained by a third party.

The server 20 is in communication with a client database 40. The database 40 is configured to provide storage of information on physical hardware 40 by, for example, executing software on the server 20. The database 40 may take many forms and may be accessible in many different manners. The database 40 allows the server 20 to store information and to retrieve information upon execution of software. The server 20 may be in communication with one or more third parties 46, as is further described below in reference to account aggregators, via a network, or through some other channel.

During operation of the system 10, the server 20 receives and stores information regarding a first portfolio of a client. The software executing on the system assigns a ranking to a client's portfolio based on a comparison of a performance of that portfolio relative to a plurality of portfolios. It should be understood that in some embodiments of the invention, the software may assign a rating based on the performance comparison, or may assign some other indicator of the performance of the first portfolio relative to the plurality of portfolios. The assigned ranking enables a comparison of the performance of the first portfolio relative to the performance of the other portfolios. Software executing on the software also rates financial advisors based on the relative performance of the portfolios that they manage.

In the embodiment disclosed in the FIGS., the server 20 hosts a website that is accessible to a plurality of client computers 60 via the internet 70. The plurality of client computers 60 can communicate with the server 20 by accessing the webpage hosted by the server 20 via the internet 70. It should be understood that in some embodiments of the present invention, the server 20 comprises a plurality of computers. For example, the server 20 may comprise a first computer for hosting the webpage, a second computer for performing backend analysis of the portfolio data, and a third computer for managing storage and access to the data and for communicating with one or more third parties, such as an account aggregator. Although the present invention discloses using an interactive website to facilitate the transfer of information between the server 20 and one or more client computers 60, the present invention is not limited in this regard. For example, the server 20 and the one or more client computers 60 may exchange information by electronic mail, or by some type of file transfer protocol.

A plurality of clients can access the system via the one or more client computers 60. The client computer 60, for example, may include a desktop computer, a laptop, a smart phone, a tablet, or any other processer based device that enables communication via the internet. Typically, a client computer 60 includes an interface that allows the client to enter information and instructions into the client computer 60 and enables the display of information to the client.

In accordance with one embodiment of the present invention, the server 20 executes software 22 to facilitate enrollment of a client. In order to participate in the portfolio ratings service offered via the server 20, a client first enrolls into the service by submitting information relevant to the client, his peer group, and his portfolio. Software executing on the server 22 generates one or more enrollment forms 50. These may include, for example, one or more pages of a website. The enrollment form 50 is transmitted by software 22 executing on the server 20 to the client computer 60 via the network 70. The enrollment form 50 can be displayed on an interface of the client computer 60. A client, using the client computer 60, enters instructions and information into the received enrollment form 50 in response to one or more requests included in the enrollment form. The client computer 60 generates a reply 52 based on the received instructions and information and transmits the reply 52 to the server 20 via the network 70.

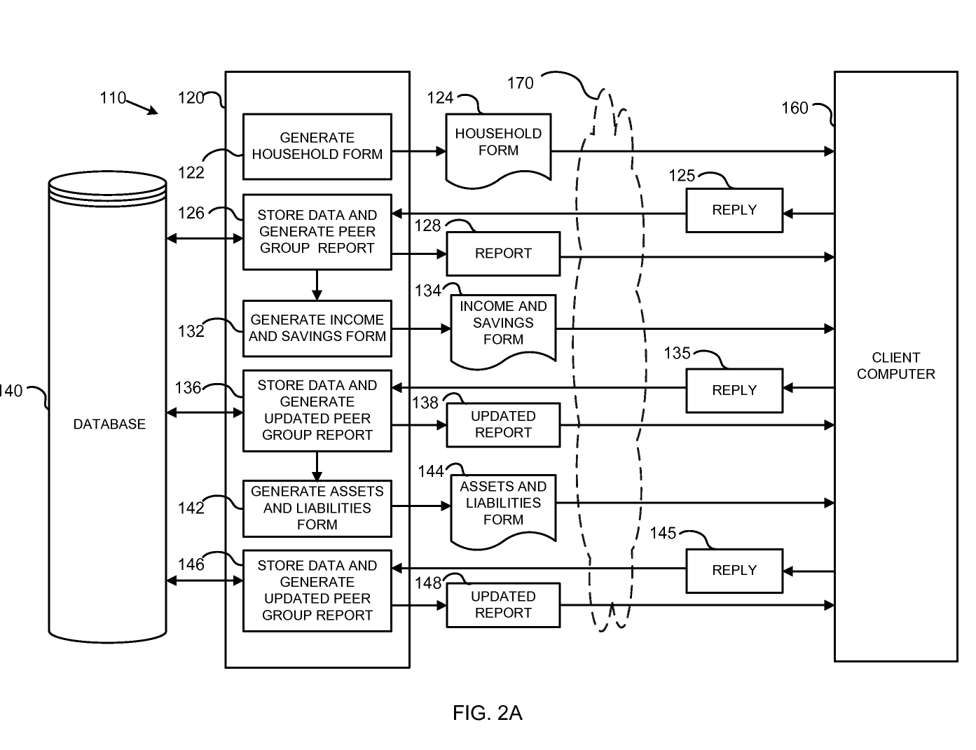

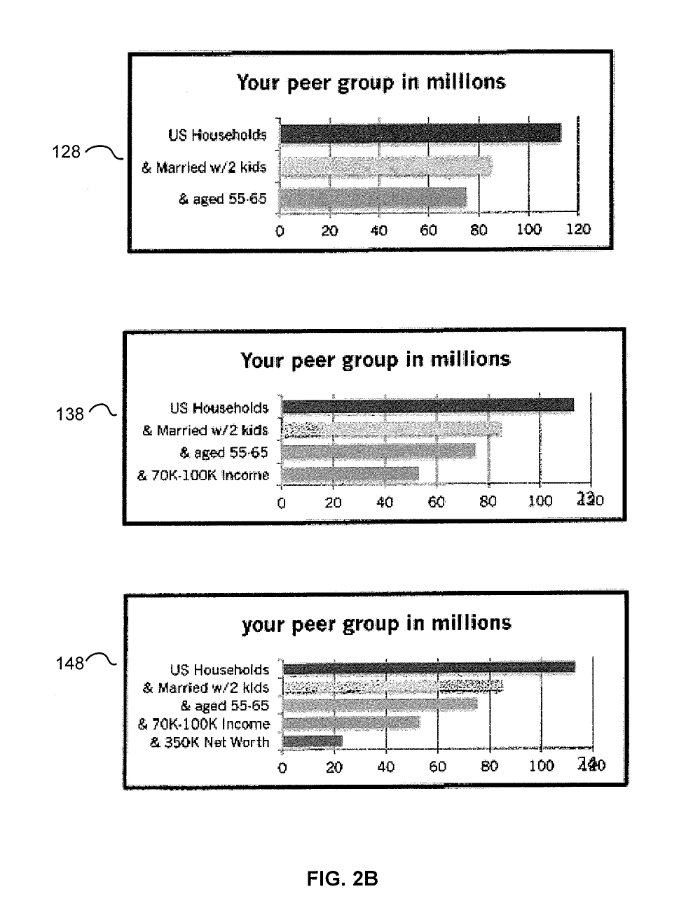

Software 26 executing on the server 20 analyzes the received reply 52 and data associated therewith. Software 26 executing on the server 20 stores the received data in the database 40. A unique client identifier is assigned to each client that uses the system 10. The received data is associated with the client identifier in the database 20. In this manner, and as more fully described below with reference to FIGS. 2A and 2B, the system 10 receives information of a client indicative of the client's peer group and financial portfolio.

In some embodiments of the present invention, for example the system 10 shown in FIG. 1, the server 20 receives information regarding a client's portfolio from one or more third parties such as the identification of financial institutions or account aggregators. Software 24 executing on the server 20 communicates with a third party 46, such as an account aggregator, and requests that it provide specific data regarding a client's portfolio. For example, the software 24 may transmit a request to the third party 26 asking it to aggregate a client's financial information from a plurality of third parties. The account aggregator 46 aggregates the requested financial information and transmits it to the server 20. Software 26 executing on the server 20 may analyze the received information. Software 26 executing on the server 20 stores the received information in the database 40 and associates it with an applicable client identifier.

For each client identifier, software 28 executing on the server 20 determines a peer group based on information received from the client computer 60. The determined peer group includes the client and other similarly situated individuals. The defined peer group enables the client to understand his financial standing and the performance of his portfolio relative to other individuals, or households, in his peer group.

Software 30 executing on the server 20 generates a report 54. The report may include, for example, information indicative of a ranking of the performance of a client's portfolio relative to performance of other portfolios of individuals in the client's peer group. The system 10 determines the rankings and performance of each portfolio based on one or more algorithms based on mathematical historical performance and various performance determinative characteristics. The system 10 transmits the report 54 to the client computer 60 via the internet 70. The client can access the report 54, and information included therein, via the client computer 60.

In reference to FIG. 2, a system and method 110 for receiving enrollment information from a client is illustrated. The system 110 may, for example, be incorporated into the system 10 shown in FIG. 1. The server 110 generates a number of web pages that are configured guide a client through the enrollment process. The information received from the client during the enrollment process defines, at least in part, the client's peer group and, at least in part, defines the client's portfolio. In one embodiment, the enrollment web pages are configured in such a manner as to employ familiar video game themes to facilitate the client's understanding of the process. The web pages may further be designed to illustrate to the client the relative progress the client has made toward completing the enrollment process.

In reference to FIG. 2A, software 122 executing on the server 120 generates a household form 124 and transmits the household form to a client computer 160 via the internet 170. The household form 124 includes one or more requests for information indicative of the client's household. For example, the household form 124 may request the number of people in the client's household. The household form 124 may request the age, occupation, education, and zip code of the head of household, and may further request similar information regarding a spouse, and dependents. The client can access and generate a reply to the household form 124 via the client computer 160. The client computer 160 transmits the reply 125 and responsive information associated therewith to the server 120 via the internet 170.

Software 126 executing on the server 120 stores the received household information in the database 140 and associates it with a relevant client identifier. Software executing on the server 126 generates a report 128 based, at least in part, on the household information received from the client via the reply 125. Software 126 executing on the server 120 transmits the report 128 to the client computer 160 via the internet 170. In reference to FIG. 2B, an example of a report 128 is illustrated. The report 128 provides an initial identification of the client's peer group based on the household information that the client provided. In this example, the client is married with two children and is between 55 and 65 years old. The generated report illustrates to the client that there are approximately 110 million households in the United States. The report 128 further illustrates that there are 85 million households in the United States with two children. The report 128 further illustrates that there are approximately 75 million households in the United States having two children, and in which the head of the household is between 55 and 65 years in age. In this manner, the report 128 provides an initial identification of the client's peer group based on the received household information included in the reply 125. In addition to providing an initial indication of the client's peer group, the report 128 facilitates the clients experience with the system and keeps the client engaged during the enrollment process. It should be understood that the peer group figures provide in reference to FIGS. 2A and 2B are provided for illustration purposes only, and may not accurately reflect the identified peer groups as they currently exist.

After receiving the household information, the system 110 moves to the next phase of the enrollment process. Software 132 executing on the server 120 generates an income and savings form 134 and transmits the income and savings form to the client computer 160 via the internet 170. The income and savings form 134 includes one or more requests for information indicative of the client's income and savings. In some embodiments, the income and savings form 134 may be configured to request certain information associated with the client's past federal or state tax returns. In this manner, the system 110 can request relevant information in a straight forward manner, without confusing the client. It should be understood that as this disclosure refers to the client, this is typically the head of household. The term client, however, may also include additional members of the household and associated financial portfolios to provide a household based portfolio performance rating as opposed to individual based portfolio rating. It should be understood, however, that the ability to define the scope and number of persons related to a portfolio may reside with the client. The use of the terms client and household in this disclose is not, in anyway, intended to limit the presently claimed invention.

The client computer 160 transmits the reply 135 to the server 120 via the internet 170. Software 136 executing on the server 120 stores the received income and savings information in the client database 140. Software 136 executing on the server 120 associates a client identifier indicative of the client with the stored information. Software 136 executing on the server 120 generates a report 138 based at least in part on the income and savings information received from the client via the reply 135.

Software 136 executing on the server 120 transmits the report 138 to the client computer 160 via the internet 170. In reference to FIG. 2B, an example of a report 138 is illustrated. The report 138 is similar to the first report 128, however, the report generated in response to the received income and savings information further narrows the definition of the peer group of the client. The report 138 provides an identification of the client's peer group based on the initial household information that the client provided and based on the received income and savings information. In the example illustrated by report 138 in FIG. 2B, the client has indicated that it has an annual household income, including 401(k) contributions, of between $70,000 and $100,000. The report 138 illustrates that there are approximately 51 million households in the United States in the client's peer group. That is households with a married couple having two children, the head of household being between 55 and 65 years old, and having an annual household income of between $70,000 and $100,000.

After receiving the household information and the savings and income information, the system 110 moves to the next phase of the enrollment process. Software 142 executing on the server 120 generates an assets and liabilities form 144 and transmits the assets and liabilities form 144 to the client computer 160 via the internet 170. The assets and liabilities form 144 includes one or more requests for information indicative of the client's assets and liabilities.

After the client inputs the necessary information, the client computer 160 transmits the reply 145 to the assets and liabilities form to the server 120 via the internet 170. Software 146 executing on the server 120 stores the assets and liabilities information in the client database 140 and associates it with a client identifier unique to the client. Software 146 executing on the server 120 generates a report 148 based on, at least in part, the assets and liabilities information received from the client via the reply 145. Software 146 executing on the server 120 transmits the report 148 to the client computer 160 via the internet 170.

In reference to FIG. 2B, an example of such a report 148 is illustrated. The report 148 is similar to the first report 128 and the second report 138, however, the third report generated in response to the received assets and liabilities information further defines the client's peer group. The report 148 provides an identification of the client's peer group based on the initial household information that the client provided, the received income and savings information, and the received assets and liabilities information. In the illustrated example, the client has indicated that it has approximately $1,000,000 in assets and $500,000 in liabilities. The report 148 illustrates that there are approximately 21 million households in the United States in the client's peer group. That is households with a married couple having two children, the head of household being between 55 and 65 years old, having an annual household income of between $70,000 and $100,000, and having approximately $1,000,000 in assets and $500,000 in liabilities.

It should be understood that the enrollment software and process is not limited to the specific sequence of events and specific requests for information described above. The enrollment process may follow many steps and may seek many different types of information indicative of a client's peer group. For example, the enrollment process may not proceed in a sequential manner as described above, but, instead, may allow the client to customize the order in which she inputs certain information into the system 110. In another embodiment, the system 110 may elicit different types of information during enrollment. For example, the system may elicit information regarding the client's profession, one or more affiliation's of the client, etc.

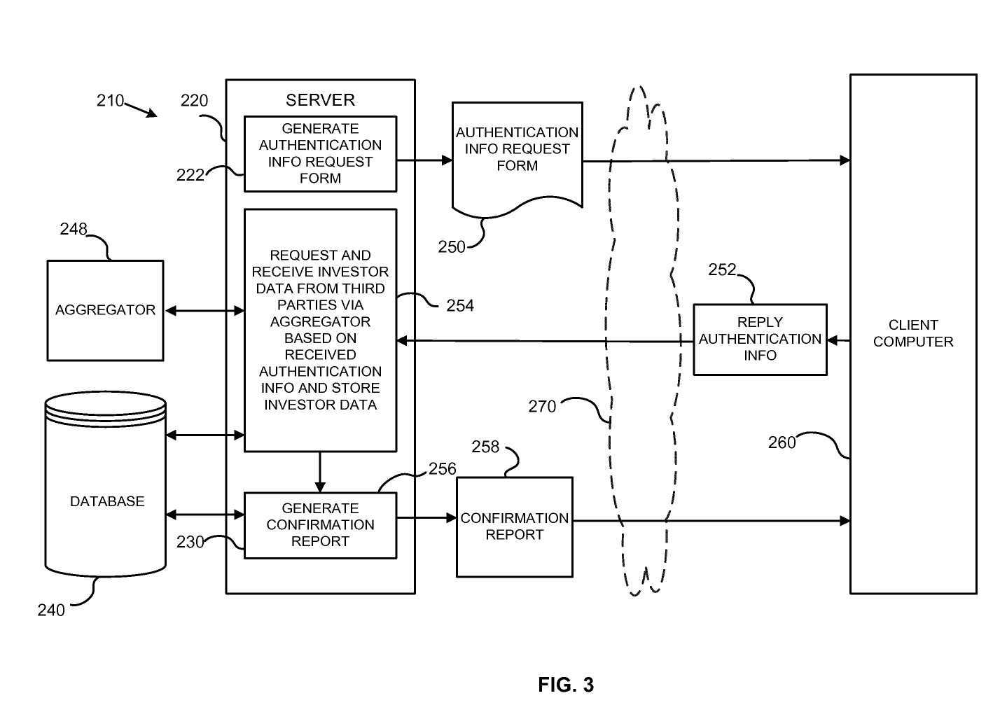

Another part of the enrollment process is obtaining financial information indicative of the client's financial portfolio. The system 210 may request this information directly from the client, or the system may request this information, with permission of the client, from one or more third party financial institutions which maintain investments of the client. In the embodiment shown in FIG. 3, the system 210 includes software 222 executing on the server 220 for generating an authentication info request form 250. The software 222 executing on the server 220 transmits the authentication info request form 250 to a client 260 via the internet 270. The authentication info request form 250 includes one or more requests for authentication information necessary for accessing the client's accounts maintained by one or more third party financial institutions. For example, the client may have one or more bank accounts maintained by third party financial institutions. Using the client computer 260, the client receives the authentication info request form 250 and inputs the requested authentication information, for example a username and password for the one or more third party accounts. The client computer 260 transmits a reply 252 having the requested authentication information included therein to the server 220 via the internet 270.

The server 220 includes software 254 executing thereon for receiving the reply 252 from the client computer 260. The software 254 generates and transmits a request, based on the received authentication information, to a third party account aggregator to aggregate the financial information of the client from the one or more third party financial institutions at which the client maintains assets. The account aggregator obtains the requested information from the relevant third party institutions and transmits it to the server 220. In some embodiments of the present invention, the account aggregator 248 provides real time or periodic updating of the client's holdings maintained by the one or more third parties. In this manner, the system in accordance with the present invention has access to near real time information regarding a client's portfolio. Although the system 220 disclosed in FIG. 3 transmits the request to a financial aggregator 248, it should be understood that the present invention is not limited in this regard. For example, the system 220 may include software executing on the server 220 for requesting the client's financial information directly from third party financial institutions instead of using an aggregator.

Software 254 executing on server 220 receives the requested financial information from the aggregator 248 and stores the information in the database 240. Software executing on the server 220 associates the client identifier with the client's financial information. In this manner, it is possible to create an accurate portrait of a client's investment portfolio and its performance during a relevant period of time, for example the past twelve months. Software 256 executing on the server 220 generates a confirmation report 258 indicating that the server 220 has received the client's requested financial information. Software 256 executing on the server 220 transmits the confirmation report 258 via the internet 270 to the client computer 260. In the embodiments described above, encryption and other security measures are implemented at every level and step of the enrollment process and during the collection and maintenance of financial information of the client from third party institutions.

The presently disclosed system and method determines and assigns a ranking to a portfolio, the ranking being indicative of the performance of the portfolio relative to a plurality of portfolios. In this manner, the client can understand and compare the performance of his investment strategy with that of others. It is preferred that the portfolio performance comparison is made among members of the same peer group. In this manner, it is possible for the client to understand how his investment strategy compares strategies of similarly situated persons. As discussed above, peer groups are based information provided by the client. This may include, but is not limited to, household information and other data received from the clients during the enrollment process. In one embodiment of the present invention, the parameters that define the peer groups are maintained by one or more administrators of the system 10. In another embodiment of the present invention, the client can define or tune the parameters to further define his other peer group. It should be understood that there are many possible ways to define the peer groups, and description of the embodiment above is not intended to limit the present invention.

In some embodiments of the present invention, software executing on the server 20 will apply one or more filters or other effects to financial data so as to account for potential errors or other abnormalities that would otherwise affect the data. For example, software executing on the server may account for certain volatilities in the performance of a client's portfolio relative to the market as a whole so as to provide an accurate illustration of the portfolio performance. In some embodiments of the present invention, the system will exclude suspect transaction from the comparison.

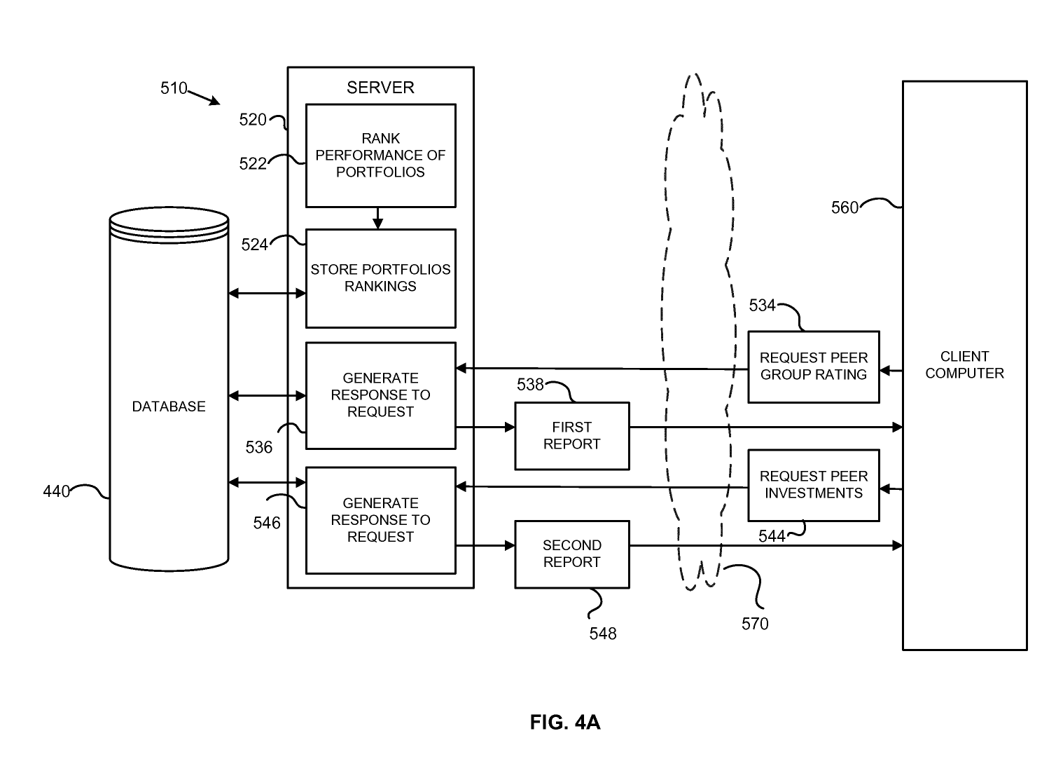

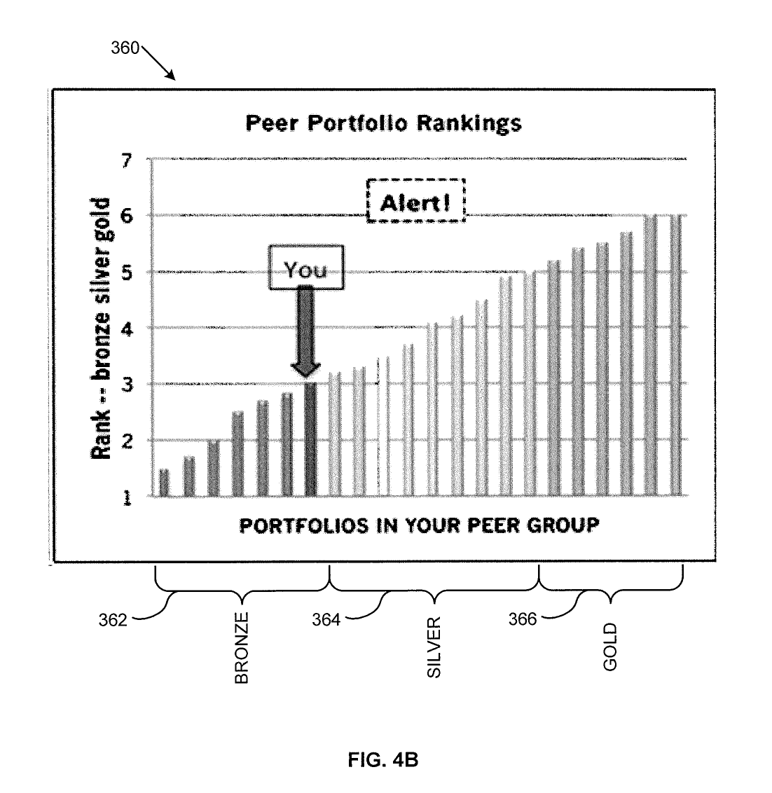

In reference to FIG. 4A, a system 510 and method for rating the performance of portfolios is illustrated. Software 522 executing on the server 520 determines and assigns a ranking to each portfolio, the ranking being indicative of the performance of that portfolio relative to the performance of a plurality of portfolios selected from the client's peer group. The software 522 relies on one or more algorithms to determine the performance of portfolios based on mathematical historical performance and various performance determinative characteristics. In the disclosed embodiment, the ranking is based on the financial data aggregated from the third party financial institutions that maintain the client's portfolio holdings. In yet other embodiments of the present invention, the ranking is based only on the performance of marketable securities of the client. Software 524 executing on the server 520 stores the assigned ranking in the database 540 and associates the applicable client identifier thereto. It should be understood that the above description for determining and assigning performance ranking to portfolios is intended to illustrate, and not limit, the present invention. A person having ordinary skill in the art will understand that the system may determine and assign the ranking based on a number of different factors.

The system 510 transmits one or more reports to client computer 560 indicative of portfolio performance relative to a peer group. In reference to FIG. 1, the server 20 transmits a report 54 to the client computer 60 via the network 70 upon completion of the enrollment process. In reference to FIG. 4A, the client computer 460 generates and transmits a request for ranking information from the server 520. In one example, the client computer 560 generates and transmits a request 534 for a peer group ranking. Software executing on the server 520 receives the request and generates a first report responsive to the request.

FIG. 4B illustrates a chart 360 generated by software executing on the server 320 for ranking a client's portfolio relative to other portfolios in the client's defined peer group. In this example, the portfolios are assigned a performance ranking between 1 and 5 based on their relative performance of each portfolio in the peer group as determined by the system 310. The performance rankings are then displayed in a bar graph to illustrate the performance of the client's portfolio relative to the performance of other portfolios owned by members of the client's peer group. It should be understood that although the chart 360 includes approximately twenty two vertical bars, the chart may illustrate a peer group that is much larger. For example, each vertical bar may represent 100, 1000, or more clients.

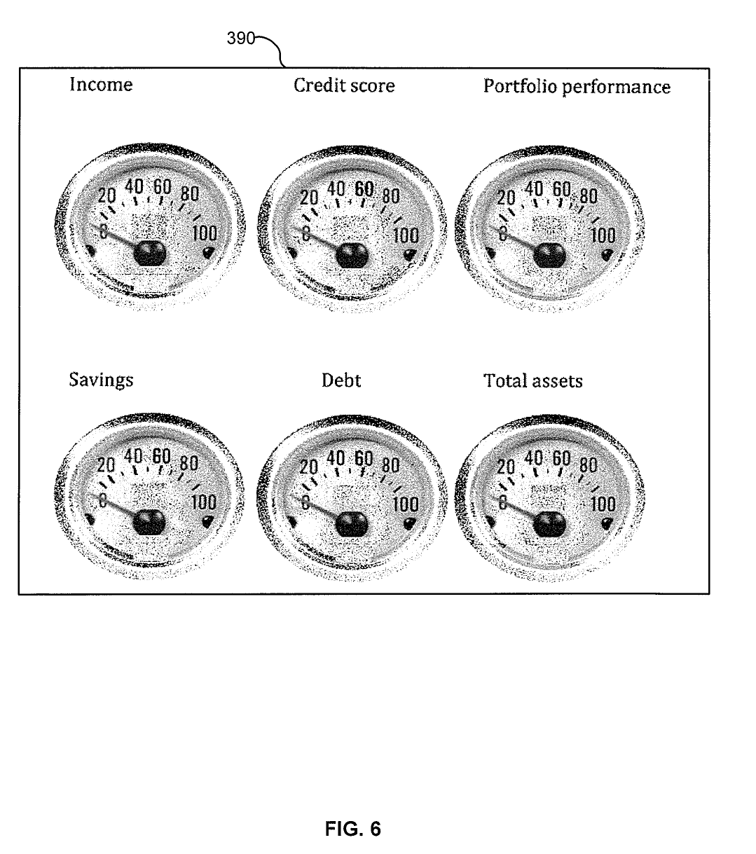

The chart 360 includes an indication showing the client the performance of his portfolio relative to the other portfolios in the peer group. The rated portfolios are divided into three categories to better illustrate the relative value of portfolios within the group. There is a bronze category for the bottom one third of performing portfolios, there is a silver category 364 for the middle one third of portfolios in the peer group, and there is a gold category 366 for the top performing one third of portfolios in the group. It should be understood that these categories and the specific chart are provided for reference only and are not intended to limit the present invention as many different types of relative portfolio performance ratings can be used with the present invention. For example, in reference to FIG. 6, a dashboard 390 includes a plurality of real-time economic gauges that display the relative performance of a client's portfolio to the performance of other portfolio's in the client's peer group.

In reference to FIG. 4A, the software executing on the client computer 560 generates a request 544 to view specific investments in a peer's portfolio. This request 544 is received by software executing on the server 520. The server generates and transmits a second report 548 to the client computer 560, the second report including information of specific holdings, or more general category of holdings of one or more portfolios in the clients peer group. In this manner, a client may target portfolios in the gold performance category and adjust her holdings based on her understanding of the higher rated portfolios to achieve improved performance. It should be understood that in this mode, client identifying information is redacted. In some embodiments, the clients are required to opt into this system and to acknowledge that others may view their financial holdings. In some embodiments, the specific holdings in a portfolio are identified. In yet other embodiments, the specific holdings are masked so as to protect the identity of the client, but still provide insight into the investment strategy that achieved a certain results. In certain embodiments of the present invention, software executing on the server processes the financial data of the portfolios in a certain category and generates an example portfolio of a hypothetical investor in that category. In this manner, the system 10 can illustrate to a client generally how a high performing portfolio in its peer group has achieved certain performance results, without revealing the holdings of specific portfolios in the peer group.

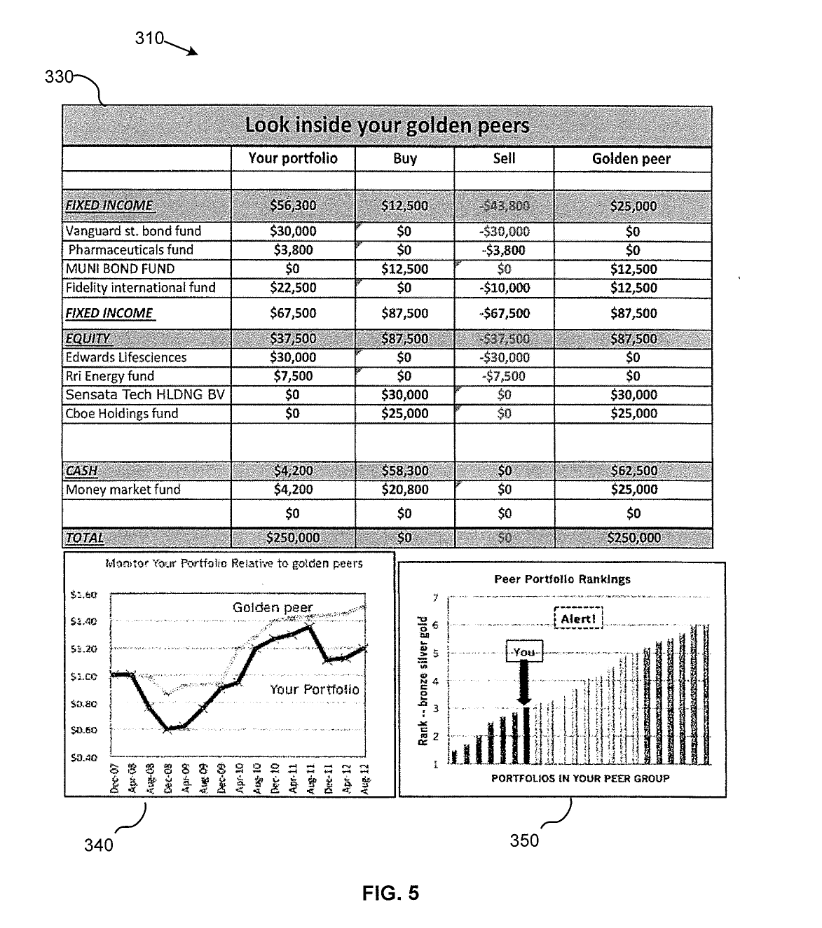

In reference to FIG. 5, an example of a second report 310 is shown. The report illustrates a client's portfolio allocation between fixed income, equities, and cash, and compares it the allocation of a top performing portfolio, “Golden peer,” in the client's peer group. The chart 310 further illustrates specific investment holdings and includes buy and sell instructions to the client how to manage his portfolio so as to more closely mirror the high performing portfolio. The second report 310 also includes a bar graph that illustrates relative performance of the client's portfolio compared to that of the golden peer over time, in the illustrated case, days. The second report also includes a small window 350 showing the first report. It should be understood that the second and first reports are provided to illustrate the present invention and are not intended to, in any manner, limited the present invention.

In some embodiments of the present invention, the system 10 includes software for monitoring the performance of portfolios within a peer group over time. The system further includes software executing on the server for alerting the client when the performance of the client's portfolio drops below a certain threshold. For example, when performance rating of the client's portfolio drops from gold to silver, software executing on the server generates an alert and transmits it the client computer via the internet.

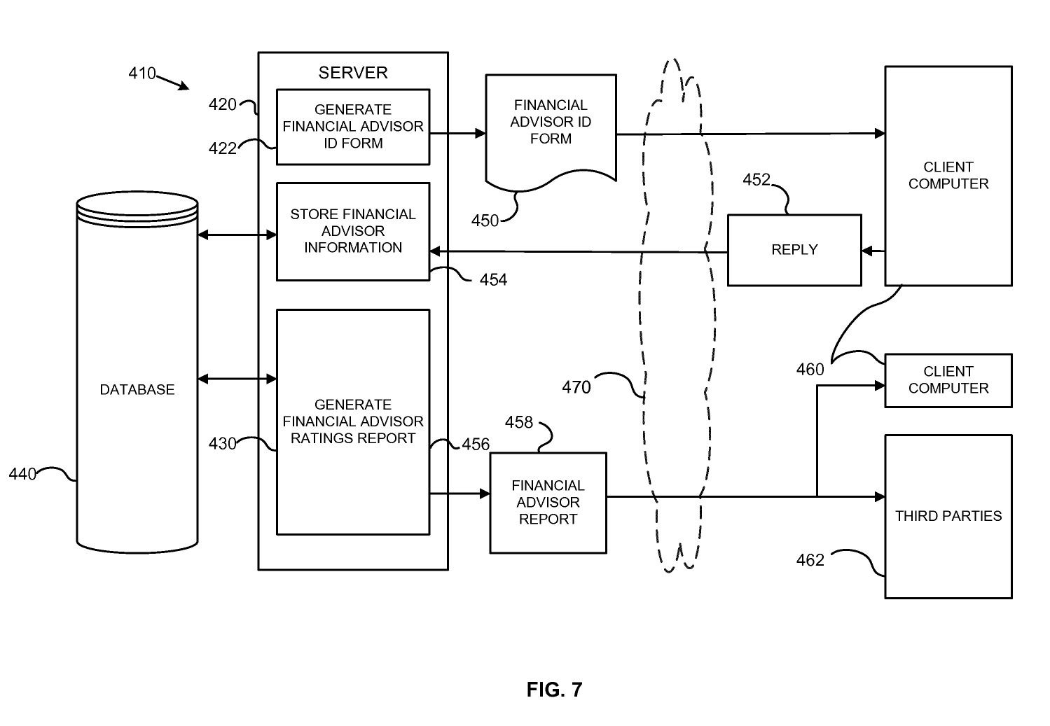

In some embodiments of the present invention, the system and method further assign ranks to financial advisors based on the performance of portfolios managed by the financial advisors within a specific peer group. In reference to FIG. 7, software 422 executing on the server 420 generates a financial advisor enrollment form 450 and transmits the form to the client computer 460 via the network. The client, via the client computer 460, responds to the form 450 by inputting the identification of the client's financial advisor, and transmits a reply including the response to the server 420. Software executing on the server 420 receives the reply 452, and stores the identity of the client's financial advisor in the database 440.

Software 430 executing on the server 430 generates a financial advisor ratings report 458 based on the performance of a financial advisors clients within a peer group. For example, the system 410 may determine and assign a rating to an advisor based on the performance of a plurality of portfolios managed by the advisor within a specific peer group. Software executing on the server 420 transmits the financial advisor report to one or more of the client 460 or third parties 462. The financial advisor report 458 provides an objective measure of the performance of a financial advisor within a peer group.

In one embodiment of the present invention, the information included in the financial advisor report 458 is made available to financial advisor firms that employs a plurality of financial advisors. In this manner, the firms have an objective measurement of the performance of their advisors. Moreover, an objective measurement of performance within a specific peer group is provided. This information will likely be highly valuable because for many years, the performance of financial advisors has been difficult to ascertain. The information included in the financial advisor report may also be made available to the clients. In this manner, the client can select a financial advisor which has a proven track record of performance for clients within her peer group. Similarly, this information could be sold to financial advisors such that a financial advisor could market on the basis that she has a highly rated performance record of portfolio management with a specific peer group.

Although the invention has been described with reference to a particular arrangement of parts, features and the like, these are not intended to exhaust all possible arrangements or features, and indeed many other modifications and variations will be ascertainable to those of skill in the art.

What is claimed is:

1. A system for ranking the performance of a first portfolio relative to the performance of a plurality of portfolios, comprising:
a server;
a database comprising a plurality of client identifiers, each of the client identifiers having a portfolio associated therewith;
software executing on the server for determining a ranking for a first portfolio associated with a first client identifier based on a comparison between the performance of the first portfolio and the performance of the plurality of portfolios, each of the portfolios being associated with a client identifier;
software executing on the server for generating a report based on the first portfolio ranking;
a communication link between the server and the internet;
software executing on server for transmitting the report to a client computer associated with the first client identifier via the communication link.

2. The system of claim 1, further comprising:
software executing on the server for generating an enrollment form;
software executing on the server for transmitting the enrollment form to the client computer via the communication link;
software executing on the server for receiving a reply from the client computer, the reply including first client data indicative of the first client and being responsive to the enrollment form;
software executing on the server for associating the received data with the first client identifier and storing the received data in the database.

3. The system of claim 2, wherein the first client data includes one or more of: household information of the first client, affiliations of the first client, income and savings of the first client, assets and liabilities of the first client, and investments of the first client.

4. The system of claim 2, wherein the first client data includes authentication information for accessing one or more financial accounts of the client maintained by one or more third parties.

5. The system of claim 4, further comprising;
software executing on the server for generating an aggregation request to retrieve account information regarding the one or more of the financial accounts of the client maintained by one or more third parties;
software executing on the server for transmitting the aggregation request to an aggregator;
software executing on the server for receiving a reply to the aggregation request, the reply including information regarding the one or more financial accounts of the client maintained by the one or more third parties;
software executing on the server for associating the received information with the first client identifier and storing the received information in the database.

6. The system of claim 3, further comprising:
software executing on the server for defining a first peer group, the first peer group including client identifiers associated with clients having one or more similarities based on the data received during enrollment.

7. The system of claim 6, wherein the date received during enrollment includes one or more of the following: a number of children, an age range, and a net worth range.

8. The system of claim 6, wherein the first portfolio and the plurality of portfolios to which the performance comparison is made are associated with client identifiers in the same peer group.

9. The system of claim 8, wherein the report illustrates a comparison between the performance of the first portfolio relative to the performance of the plurality of portfolios.

10. The system of claim 9, further comprising:
software executing on the server for receiving a request from the client computer via the communication link for data indicative of a holding of one or more of the plurality of portfolios in the first peer group;
software executing on the server for generating a response to the request, the response including the requested data;
software executing on the server for transmitting the response to the client computer via the communication link.

11. The system of claim 6, further comprising:
software executing on the server for generating a financial advisor identification form;
software executing on the server for transmitting the financial advisor identification form to the client computer via the communication link;
software executing on the server for receiving a reply to the financial advisor identification form, the reply including a financial advisor identifier indicative of a financial advisor associated with the first client;
software executing on the server for storing the financial advisor identifier in the database and software for associating the financial advisor identifier with the performance of the first client's portfolio.

12. The system of claim 11, further comprising:
software executing on the server for determining a first financial advisor performance rating by comparing a performance of a plurality of portfolios associated with a first financial advisor with a performance of a plurality of portfolios, each of the plurality of portfolios being associated with a financial advisor different than the first financial advisor.

13. The system of claim 12, wherein the financial advisor rating is based on a comparison of the performance of the financial advisor within a peer group.

14. A method for ranking the performance of a first portfolio relative to the performance of a plurality of portfolios, comprising:
providing a plurality of client identifiers, each of the client identifiers having a portfolio associated therewith;
determining a ranking for a first portfolio associated with a first client identifier based on a comparison between the performance of the first portfolio and the performance of a plurality of portfolios, each of the portfolios being associated with a client identifier;
generating a report based on the first portfolio ranking;
transmitting the report to a client associated with the first client identifier.

15. The method of claim 14, further comprising the steps of:
generating an enrollment form;
transmitting the enrollment form to the client;
receiving a reply from the client computer, the reply including first client data indicative of the first client and being responsive to the enrollment form;
associating the received data with the first client identifier and storing the received data in the database.

16. The method of claim 15, further comprising the steps of:
defining a first peer group, the first peer group including client identifiers associated with clients having one or more similarities based on the data received during enrollment.

17. The method of claim 16, wherein the first portfolio and the plurality of portfolios to which the performance comparison is made are associated with client identifiers in the same peer group.

18. The method of claim 17, further comprising the steps of:
generating a financial advisor identification form;
transmitting the financial advisor identification form to the client computer;
receiving a reply to the financial advisor identification form, the reply including a financial advisor identifier indicative of a financial advisor associated with the first client;
storing the financial advisor identifier in the database.

19. The method of claim 18, further comprising the steps of:
determining a first financial advisor performance rating by comparing a performance of a plurality of portfolios associated with a first financial advisor with a performance of a plurality of portfolios, each of the plurality of portfolios being associated with a financial advisor different than the first financial advisor.

20. The method of claim 19, wherein the financial advisor rating is based on a comparison of the performance of the financial advisor within a peer group.
